(19) United States
(12) Patent Application Publication
(10) Pub. No.: US 2010/0283170 A1
(43) Pub. Date: Nov. 11, 2010

(54) FABRICATING METHOD FOR SLEEVE-TYPE ORNAMENT OF DISPLAY DEVICE

(76) Inventor: Wen-Hung HUANG, Taipei County (TW)

Correspondence Address: Guice Patents PLLC, 12647 Galveston Court #302, Manassas, VA, 20112, US

(21) Appl. No.: 12/534,112

(22) Filed: Aug. 1, 2009

(30) Foreign Application Priority Data
May 11, 2009 (TW) 098115518

(51) Int. Cl. C08J 9/06; B29C 33/42

(52) U.S. Cl. 264/54; 264/219

(57) ABSTRACT

The present invention provides a fabricating method for sleeve-type ornament of display device, comprising the steps of: a step of providing a display device, a 3D image file is provided with respect to the display device; a step of shaping an ornament, the surface of the decoration portion of the display device is shaped with a shaping material, so a layer of original ornament mold is formed on the surface of the decoration portion of the display device; a step of scanning the original ornament mold, a scanner is used to scan the shape of the original ornament mold, and the obtained data is transferred to a computer for establishing a 3D image file of the original ornament mold; a step of establishing a 3D image file of the ornament, the scanned 3D image file of the original ornament mold and the 3D image file of the display device are opened through a software in a computer, and the images of the two 3D image files are overlapped, part of the image of the display device that is overlapped within the image of the original ornament mold is removed through a command, so a 3D image file of the ornament, excluding the display device, is obtained; and a step of model fabrication, the 3D image file of the ornament is encoded to a compiler code that is recognizable for a molding machine for fabricating an ornament model.

### BACKGROUND OF THE INVENTION

1. Field of the Invention

The present invention relates to a fabricating method for sleeve-type ornament of display device, more particularly to a fabricating method for sleeve-type ornament of display device made of polyurethane foam.

2. Description of Related Art

With the ever changing and developing technologies, a conventional display device CRT is gradually replaced by a flat panel display device, e.g. a LCD TV, LCD display devices are widely used in computer monitors, televisions or digital photo frames, etc., and have brought a more convenient way of life to us.

The above mentioned flat panel display device is often made with a means of a LCD panel installed in a housing, in view of production cost, the shape of the housing is often in a rectangular shape which is hard to distinct from conventional and stereotype impressions. Therefore the design of LCD TV merely focuses on changes in size and the style of housing base, which lack of a unique integrated shape and style.

The periphery of the LCD panel is installed with a rectangular housing, thus skilled people in the art have developed a rectangular stuffed decoration object made of fabric materials so as to cover the object on the periphery of the four side frames of the display device, thus a display device with a unique appearance and can present the personal taste is obtained. But the stuffed decoration object is made of fabric materials, the object may easily have stains or dust thereon, the heat dissipating effect is poor, and easily generated static electricity.

With respect to the above mentioned disadvantages, skilled people in the art have developed an ornament made of polyurethane (PU) foam; with the properties of shock-absorbing, elastic, anti-thermal, insulation and capable of being coated provided by PU foam. A conventional fabricating method for the ornament made of polyurethane (PU) foam is that an image file of the 3D (three dimensional) shape and size of the ornament is drawn through a 3D CAD software, e.g. PRO/E, on a computer, then the image file is converted and encoded to a compiler code that can be recognized by a CNC (Computerized Numerical Controlled) machine or a RP (rapid prototyping) machine, then an ornament model is fabricated through carving and stacking according to the compiler code. Then operations of molding and massive production are processed for fabricating the ornament made of polyurethane (PU) foam.

Though the 3D ornament model can be made through the 3D image file for achieving an object of discussing shape and color of the ornament before operations of molding and massive production; most of the times during the designing processes of the 3D ornament model, the appearance or structure may required further modification of the 3D ornament model and the 3D image file has to be changed and a new 3D ornament model has to be remade. During the product devolvement, only the final 3D model of the ornament can be used for molding and massive production, so other models made during the designing processes have to be wasted and the cost for model fabrication is unnecessary wasted and the product development process is longer.

### SUMMARY OF THE INVENTION

One object of the present invention is to provide a fabricating method for sleeve-type ornament of display device, with advantages of shortening fabrication times of 3D models, reducing structural deviation and shortening product development period.

Another object of the present invention is to provide a fabricating method for sleeve-type ornament of display device, a sleeving section between the sleeve-type ornament and the display device has a high precision in shape and size for achieving an accurate and tight combination.

For achieving the objects mentioned above, one solution provided by the present invention is to provide a fabricating method for sleeve-type ornament of display device, comprising the steps of:

a step of providing a display device, a 3D image file is provided with respect to the display device;

a step of shaping an ornament, the surface of the decoration portion of the display device is shaped with a shaping material, so a layer of original ornament mold is formed on the surface of the decoration portion of the display device;

a step of scanning the original ornament mold, a scanner is used to scan the shape of the original ornament mold, and the obtained data is transferred to a computer for establishing a 3D image file of the original ornament mold;

a step of establishing a 3D image file of the ornament, the scanned 3D image file of the original ornament mold and the 3D image file of the display device are opened through a 3D software in a computer, and the images of the two 3D image files are overlapped, part of the image of the display device that is overlapped inside of the original ornament mold and is removed to create a accurate 3D image file of the ornament, excluding the display device; and

a step of model fabrication, the 3D image file of the ornament is encoded to a compiler code that is recognizable for a CNC or RP machine for fabricating an ornament model;

wherein between the step of shaping the ornament and the step of scanning the original ornament mold further includes steps of:

a step of shape designing process, the original ornament mold is discussed whether needed to be modified in shape, appearance or size, until the final shape, appearance and size of the original ornament mold are determined.

After the step of model fabrication, the present invention further includes steps of: a step of color planning, the surface of the ornament model is coated so as to simulate the final result of shape and color of the finished product;

a step of color scheme finalizing, the arrangement of shape and color of the ornament model is discussed until the step of color planning is finalized;

a step of molding, the ornament model after processed with the step of color planning is fabricated to a mold;

a step of fabrication, polyol and isocyanate and other related agents are provided in the mold for processing a chemical reaction so as to form a semi-finished ornament made of PU foam;

a step of coating, the semi-finished ornament is coated with the color determined at the step of color planning, so a finished product of sleeve-type ornament is obtained.

### BRIEF DESCRIPTION OF THE DRAWINGS

FIG. 1 is a flowchart of the fabricating method provided by the present invention;

FIG. 2 is an elevational view of the display device of the present invention;

FIG. 3 is an elevational view illustrating the housing of the display device being processed with ornament shaping;

FIG. 4a is a schematic view illustrating the 3D image of the display device and the 3D image of the ornament being overlapped in computer software;

FIG. 4b is a schematic view illustrating part of the 3D image of the display device that is overlapped within the 3D image of the ornament being removed in computer software;

FIG. 5 is an elevational view of the ornament model of the present invention;

FIG. 6 is a view of the finished product of sleeve-type ornament of the present invention.

### DETAILED DESCRIPTION OF THE PREFERRED EMBODIMENT

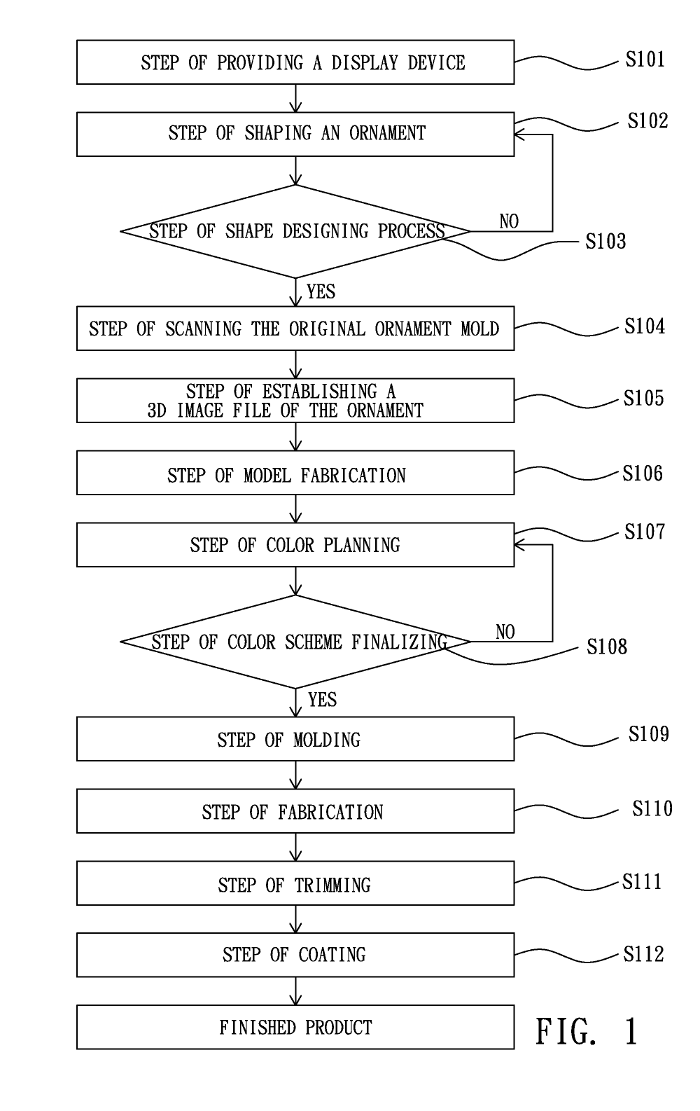

Referring to FIG. 1, the fabricating method for sleeve-type ornament of display device provided by the present invention comprises the steps of: a step of providing a display device (S101); a step of shaping an ornament (S102); a step of shape designing process (S103), a step of scanning the original ornament mold (S104); a step of establishing a 3D image file of the ornament (S105); a step of model fabrication (S106); a step of color planning (S107); a step of color scheme finalizing (S108); a step of molding (S109); a step of fabrication (S110); a step of trimming (S111) and a step of coating (S112).

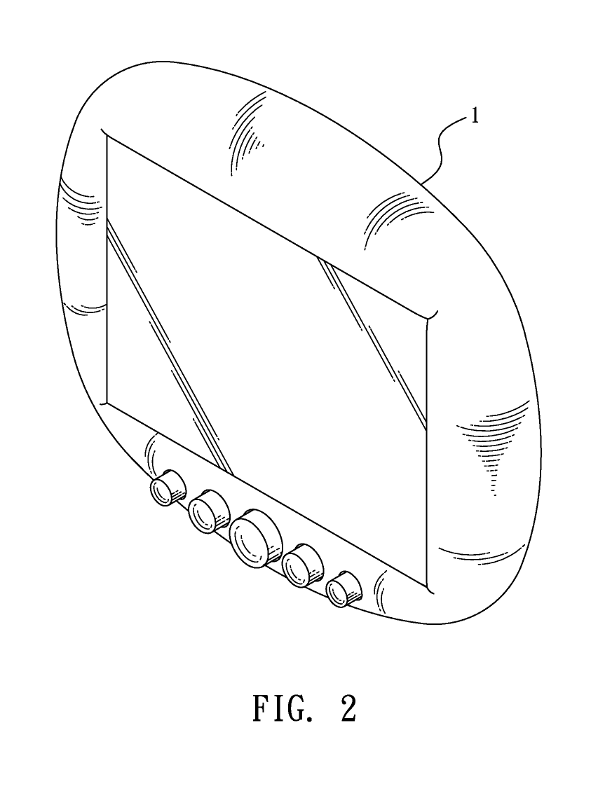

In the step of providing a display device (S101), an actual finished product of the display device 1 as shown in FIG. 2 is provided; or the specification of the display device 1 is determined, a 3D image file is established through a 3D CAD software and is converted and output for making a model of the display device 1. So in this step, whether the finished product of display device 1 is provided or a model thereof is made, the 3D image file with determined size and shape of the display device 1 can be obtained in a computer 5 for further processing the step of establishing a 3D image file of the ornament (S105).

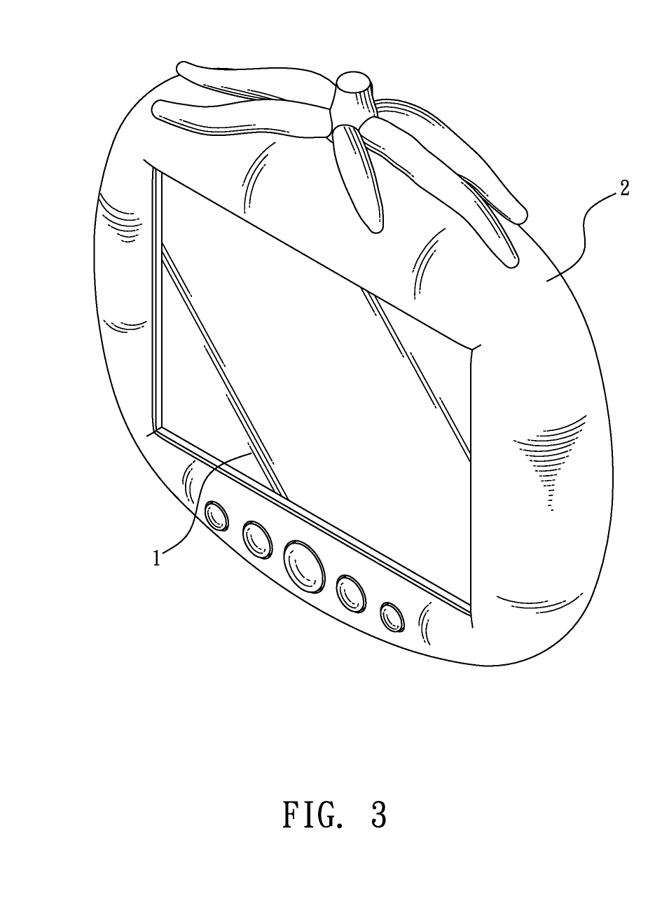

In the step of shaping an ornament (S102), the decoration portion of the display device 1, e.g. peripheral frames of the housing, is shaped through a shaping material, e.g. oil clay or paper clay, according to a specific or irregular shaping design; the shaping means can be hand carving, machine carving or combination of the two, so a layer of original ornament mold 2 as shown in FIG. 3 is shaped on the surface of the display device 1.

In the step of shape designing process (S103), the original ornament mold 2 made according to the above mentioned steps is discussed by development division personnel and other related divisions, sales or managements to determine whether the original ornament mold 2 requires to be modified in its shape, appearance or size; if the result of the discussion is no modification needed, than the step of scanning the original ornament mold (S104) is proceeded; if the result of the discussion is that an modification is needed, then back to the step of shaping the ornament (S102) and modified by hands or machines then the step of shape designing process (S103) is again proceeded until the shape, appearance and size of the original ornament mold 2 are determined.

In the step of scanning the original ornament mold (S104), a scanner is used to scan the ornament mold 2, as shown in FIG. 3, the obtained data is transferred to a computer 5 for establishing a 3D image file of the original ornament mold 2.

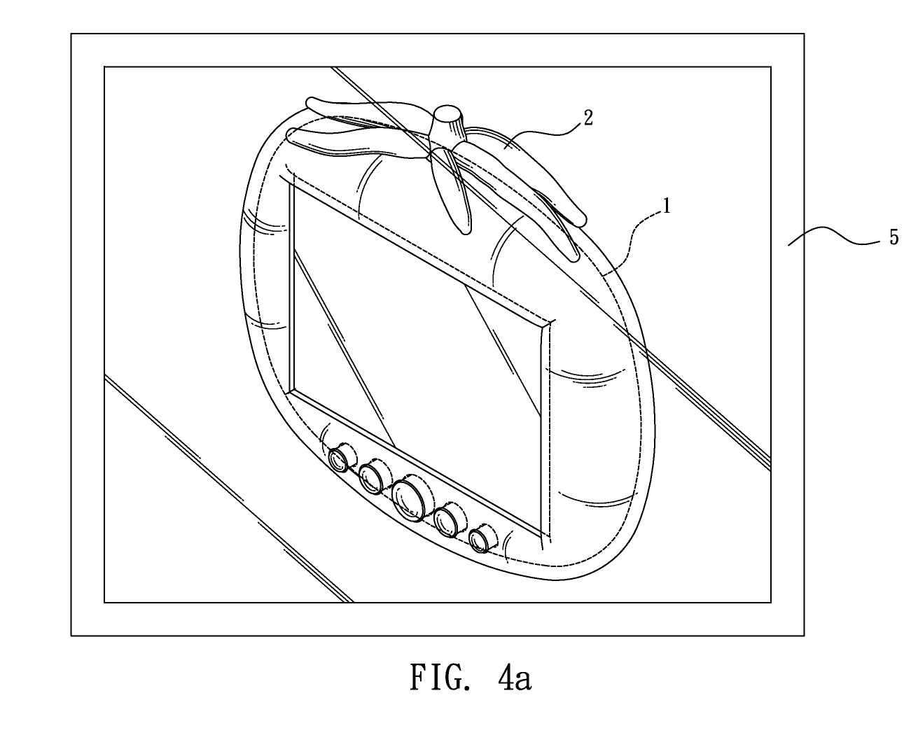

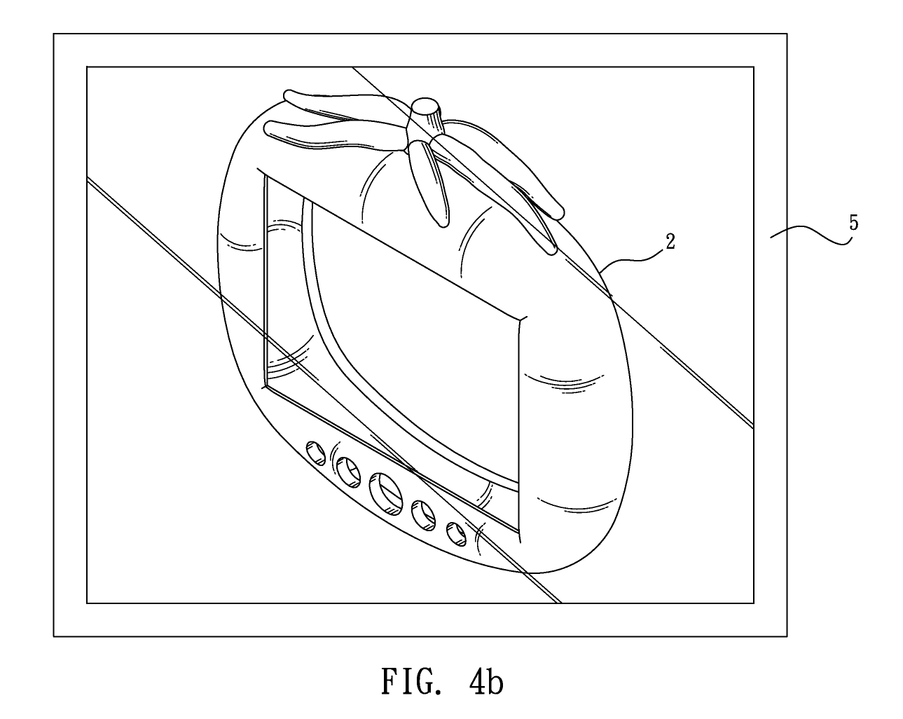

In the step of establishing a 3D image file of the ornament (S105), the scanned 3D image file of the original ornament mold 2 and the 3D image file of the display device 1 are opened through a 3D CAD software, and the two 3D images of the two 3D image files, as shown in FIG. 4a, are overlapped, the overlapping means is that common feature spots of the images of the display device 1 and the original ornament mold 2, e.g. four panel corners, buttons or keys, are served as foundations and the common feature spots of the two images, then the portion of the image of the display device 1 that is overlapped within the image of the original ornament mold 2, and is removed through a command, so a hollow section is formed at the center of the image of the original ornament mold 2, then the image file is saved so as to establish an accurate 3D image file of the ornament, excluding the display device 1, as shown in FIG. 4b. Because the shape and size of inner edges of the image of the 3D image file of the ornament are obtained through removing part of the image of the display device 1, the shape and size of the hollow concave slot of the 3D image file of the ornament are exactly matching with the four peripheral frames of the housing of the display device 1, a high precision of matching shape and size is achieved.

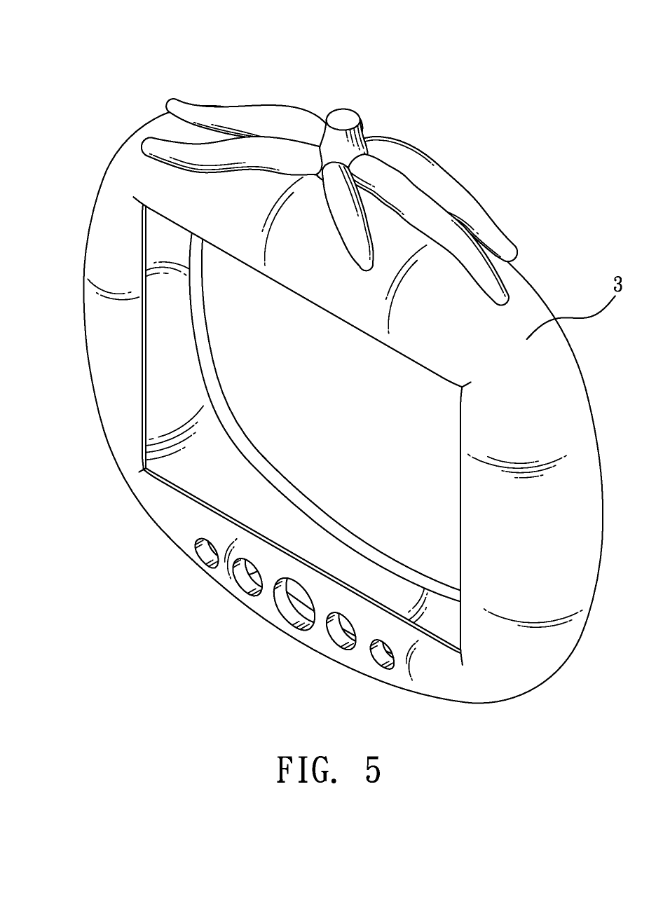

In the step of model fabrication (S106), the 3D image file of the ornament obtained through the above mentioned steps is encoded to a compiler code that is recognizable for a CNC (Computerized Numerical Controlled) machine or a RP (rapid prototyping) machine, so a ornament model 3, as shown in FIG. 5, is made by the above mentioned molding machine.

After the ornament model 3 is made, the step of color planning (S107) can proceeded, in this step (S107), the surface of the ornament model 3 is coated to simulate the shape and color of the finished product for presenting an actual viewing sensation.

The coated ornament model 3 is then processed with the step of color scheme finalizing (S108), the arrangement of shape and color of the ornament model 3 is discussed by the development division or other related divisions such as sales or managements; if no modification is required, the ornament model 3 can be further processed with the step of molding (S109); if the arrangement of color of the ornament model 3 needs to be modified, then back to the step of color planning (S107), the arrangement of color is proceeded again until the color planning is determined, then the ornament model 3 is proceeded with the step of molding (S109).

In the step of molding (S109), the ornament model 3 after being processed with the step of color planning is fabricated to a mold.

In the step of fabrication (S110), polyol, isocyanate and addition agents such as foaming agent, catalyst, surfactant, anti-flaming agent, etc., are provided inside the mold for generating a chemical reaction, so a semi-finished ornament made of PU foam is obtained in the mold.

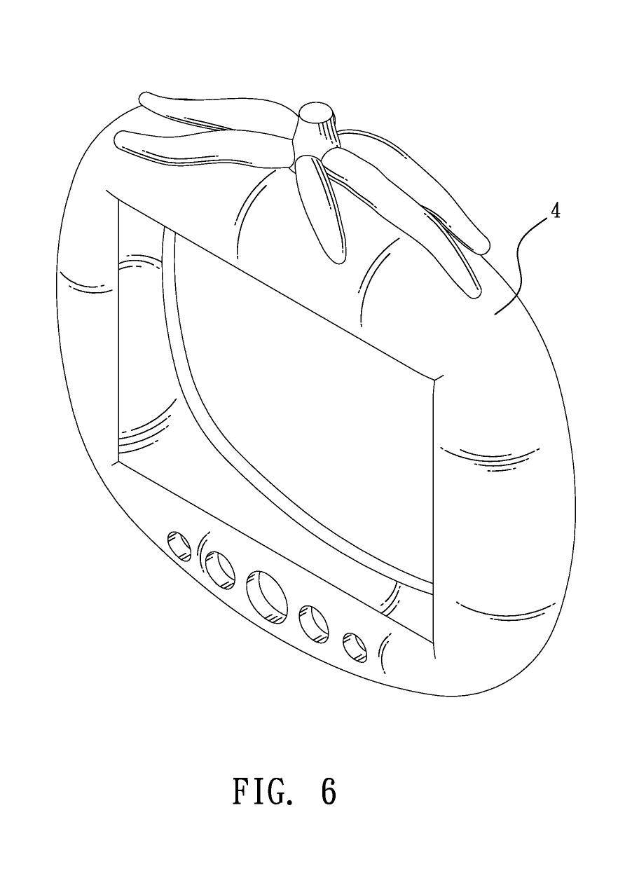

The semi-finished product is then processed with the step of trimming (S111) for example trimming burrs, then the step of coating (S112) is proceeded so that the semi-finished ornament is coated with the color determined in the step of color planning (S107), a finished product of sleeve-type ornament 4 as shown in FIG. 6 is therefore obtained.

The advantages of the present invention are as followings: the shape and size of the original ornament mold 2 fabricated in the step of shaping the ornament (S102) simulate the actual shape and size of the ornament, then is scanned, so a 3D image file of the original ornament mold 2 is established in a computer 5; the image of the 3D image file of the original ornament mold 2 and the image of the 3D image file of the display device 1 are overlapped then the portion of the image of the display device 1 that is overlapped within the image of the original ornament mold 2 is removed through a command, a 3D image file of the ornament with high precision in shape and size is obtained, thus only an ornament model is needed to be fabricated according to the fabricating method provided by the present invention; compared with the prior art that a 3D image file is firstly modified then output for fabricating an ornament model, then a discussion about the shape of the ornament can be proceeded, the fabricating method of the present invention reduced the fabrication times so the product development period can be greatly shortened, e.g. fabrication and discussion time of an ornament model, and a requirement of high precision in the shape and size of the sleeving section between the ornament and the display device is able to be satisfied.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A fabricating method for sleeve-type ornament of display device, comprising the steps of:
a step of providing a display device, a 3D image file is provided with respect to the display device;
a step of shaping an ornament, a surface of a decoration portion of the display device is shaped with a shaping material, and an original ornament mold is formed on the surface of the decoration portion of the display device;
a step of scanning the original ornament mold, a scanner is used to scan the shape of the original ornament mold, and an obtained data is transferred to a computer for establishing a 3D image file of the original ornament mold;
a step of establishing a 3D image file of the ornament, the scanned 3D image file of the original ornament mold and the 3D image file of the display device are opened through a software in a computer, and the images of the two 3D image files are overlapped, part of the image of the display device that is overlapped within the image of the original ornament mold is removed through a command, and a 3D image file of the ornament, excluding the display device, is obtained; and
a step of model fabrication, the 3D image file of the ornament is encoded to a compiler code that is recognizable for a molding machine for fabricating an ornament model.

2. The fabricating method for sleeve-type ornament of display device as claimed in claim 1, wherein in the step of providing the display device, the display device is a finished product or a three-dimension model.

3. The fabricating method for sleeve-type ornament of display device as claimed in claim 1, wherein in the step of shaping the ornament, the decoration portion of the display device is located on peripheral frames of the housing of the display device.

4. The fabricating method for sleeve-type ornament of display device as claimed in claim 1, wherein the shaping material is oil clay or paper clay.

5. The fabricating method for sleeve-type ornament of display device as claimed in claim 1, wherein between the step of shaping the ornament and the step of scanning the original ornament mold further includes steps of:
a step of shape designing process, the original ornament mold is discussed whether needed to be modified in shape, appearance or size, until the shape, appearance and size of the original ornament mold are determined.

6. The fabricating method for sleeve-type ornament of display device as claimed in claim 1, wherein in the step of establishing the 3D image file of the ornament, common feature spots of the image of the 3D image file of the display device and the image of the 3D image file of the ornament are served as foundations, and the common feature spots of the two images are overlapped.

7. The fabricating method for sleeve-type ornament of display device as claimed in claim 1, wherein in the step of model fabrication, the molding machine is a computerized numerical controlled machine or a rapid prototyping machine.

8. The fabricating method for sleeve-type ornament of display device as claimed in claim 1, wherein after the step of model fabrication, further includes steps of:
a step of color planning, a surface of the ornament model is coated to simulate the result of shape and color of the finished product;
a step of color scheme finalizing, an arrangement of shape and color of the ornament model is discussed until the step of color planning is finalized;
a step of molding, the ornament model after processed with the step of color planning is fabricated to a mold;
a step of fabrication, polyol, isocyanate and at least one agent are added in the mold for generating a chemical reaction so as to form a semi-finished ornament made of PU foam; and
a step of coating, the semi-finished ornament is coated with the color determined at the step of color planning, and a finished product of sleeve-type ornament is obtained.

9. The fabricating method for sleeve-type ornament of display device as claimed in claim 8, wherein the addition agents is a foaming agent, catalyst, surfactant or anti-flaming agent.

10. The fabricating method for sleeve-type ornament of display device as claimed in claim 8, wherein the semi-finished product of ornament fabricated in the step of fabrication further be processed with a step of trimming for trimming burrs.
